(19) United States
(12) Patent Application Publication
(10) Pub. No.: US 2026/0227509 A1
(43) Pub. Date: Aug. 6, 2026

(54) METHOD AND DEVICE FOR MEASURING AN EXTERNAL SURROUND OF A VEHICLE BY MEANS OF ULTRASOUND

(71) Applicant: Valeo Schalter und Sensoren GmbH, Bietigheim-Bissingen (DE)

(72) Inventor: Fabian Haag, Bietigheim-Bissingen (DE)

(73) Assignee: Valeo Schalter und Sensoren GmbH, Bietigheim-Bissingen (DE)

(21) Appl. No.: 19/150,530

(22) PCT Filed: Jan. 10, 2024
(86) PCT No.: PCT/EP2024/050428

§ 371 Date: Jul. 23, 2025

(30) Foreign Application Priority Data
Jan. 23, 2023 (DE) 10 2023 101 519.2

(51) Int. Cl. G01S 15/931; G01S 7/521

(52) U.S. Cl. CPC G01S 15/931; G01S 7/521

(57) ABSTRACT

Described is a method for measuring an external surround of a vehicle. The method includes determining an ambient temperature of an ultrasonic transceiver of the vehicle, selecting a carrier frequency for an ultrasonic transmission signal of the ultrasonic transceiver on the basis of the determined ambient temperature of the ultrasonic transceiver, transmitting the ultrasonic transmission signal at the selected carrier frequency into the external surround of the vehicle by means of the ultrasonic transceiver, and receiving an ultrasonic reception signal by means of the ultrasonic transceiver.

The present invention relates to a method and a device for surveying an external environment of a vehicle by means of ultrasound. The present invention furthermore relates to a computer program product.

Vehicles, in particular motor vehicles, are equipped with ultrasonic transceivers, which emit ultrasonic transmission signals into an environment of the vehicle and receive ultrasonic reception signals from the environment of the vehicle. A distance to the object in the environment of the motor vehicle is determined by means of a signal propagation time between the emission of an ultrasonic transmission signal and the arrival of an ultrasonic echo in the ultrasonic reception signal which is due to a reflection of the ultrasonic transmission signal at an object in the environment of a vehicle. The actual position of the reflection point can be determined by trilateration or the like. In trilateration, an object like a post is substantially point-shaped when viewed two-dimensionally.

In particular in the case of automated driving, for example in the case of automated parking or in the case of automated approaching, small or narrow obstacles such as posts or horizontal bars must also be identified reliably. The temperature-dependent directional characteristic of the ultrasonic transceivers can make such identification more difficult at different temperatures.

U.S. Pat. No. 805,420,213 B2 discloses a method for determining whether an object is situated in the interior of a vehicle, in which method the frequency of an ultrasonic horn is changed as a function of the temperature in order to keep the wavelength constant.

Against this background, an object of the present invention is to further improve the surveying of an external environment of a motor vehicle by means of ultrasound.

Accordingly, a method for surveying an external environment of a vehicle is proposed, wherein the method comprises the following steps: determination of an ambient temperature of an ultrasonic transceiver of the vehicle; selection of a carrier frequency of an ultrasonic transmission signal of the ultrasonic transceiver as a function of the determined ambient temperature of the ultrasonic transceiver; transmission of the ultrasonic transmission signal at the selected carrier frequency into the external environment of the vehicle by means of the ultrasonic transceiver; and reception of an ultrasonic reception signal by means of the ultrasonic transceiver.

In the case of a constant-temperature carrier frequency, the wavelength of the ultrasonic transmission signal changes as a result of a change in the ambient temperature. The change in the wavelength results in a changed directional characteristic of the ultrasonic transmission signal. By selecting the carrier frequency of the ultrasonic transmission signal as a function of the ambient temperature, the wavelength of the ultrasonic transmission signal can be kept constant at different ambient temperatures or at least a change in wavelength as a function of the ambient temperature can be reduced. The directional characteristic of the ultrasonic transceiver can be kept constant or at least the change in the directional characteristic by the ambient temperature can be reduced by means of a wavelength which is constant at different ambient temperatures or at least a reduced change in wavelength.

A temperature that is important for the propagation of the ultrasonic transmission signal is the temperature of a medium in which the ultrasonic transmission signal propagates, generally the surrounding air in which the ultrasonic transmission signal propagates. In embodiments, therefore, in particular, the temperature of the air in which the ultrasonic transmission signal propagates is measured and used as ambient temperature. However, it is also possible, for example, to measure a temperature of a sensor, a temperature of a bumper or a temperature at another location, for example when transmitting ultrasonic transmission signals in the front region of the vehicle, a temperature from the rear region of the vehicle, and to use said temperature as ambient temperature.

A distance between an object and the ultrasonic transceiver can be calculated from ultrasonic echoes in the ultrasonic reception signal, which are based on a reflection of the ultrasonic transmission signal at an object in the external environment of the vehicle. If a plurality of ultrasonic transceivers are used, the position of the object can be determined by trilateration.

The carrier frequency can be selected as a function of the ambient temperature by means of a look-up table in which values for carrier frequencies for ambient temperatures and/or ranges of ambient temperatures are stored. Alternatively or in combination, the selection of the carrier frequency can be calculated by a formula which is stored in a processor with a memory. The carrier frequencies of the look-up table or of the formula can be determined by calculation, by simulations or by measurements.

An ultrasonic transceiver is often optimized for a specific optimum transmission carrier frequency or a narrow frequency band around this optimum transmission carrier frequency. In the case of ultrasonic transceivers frequently used in vehicles, a diaphragm, in particular made of metal, is excited by a piezo element. The piezo element is electrically excited. This type of electroacoustic transducer represents a resonant system. If a carrier frequency is selected to be different from the optimum transmission carrier frequency for exciting the piezo element, the power that is output by the ultrasonic transmission signal is reduced.

In the reception path, the ultrasonic transceiver is often likewise optimized for a specific optimum reception carrier frequency or a narrow frequency band around this optimum reception carrier frequency. If the ultrasonic transceiver receives an ultrasonic reception signal at a carrier frequency different to the optimum reception carrier frequency, an electrical power is reduced in the conversion of the ultrasonic reception signal into an electrical signal.

In embodiments, an ultrasonic transceiver with a transfer function is sought, in which attenuation of the ultrasonic transmission signal, in particular of the sound pressure, by 3 dB with respect to the maximum of the ultrasonic transmission signal at the optimum carrier frequency occurs only in the event of a deviation from 3 kHz, preferably 5 kHz. If the optimum carrier frequency is, for example, 52 kHz, attenuation of the ultrasonic transmission signal by 3 dB should preferably occur only at carrier frequencies greater than 57 kHz or less than 47 kHz.

In embodiments, the carrier frequency for the ultrasonic transceiver is between 42 and 62 kHz, preferably between 45 and 59 kHz, more preferably between 48 and 56 kHz.

According to embodiments, an electrical power supplied for generating the ultrasonic transmission signal and/or an amplification of an electrical signal into which the ultrasonic reception signal is converted by the ultrasonic transceiver is selected as a function of the selected carrier frequency of the ultrasonic transmission signal.

If the selected carrier frequency differs from the optimum carrier frequency, less electrical power is converted into mechanical power in different types of ultrasonic transceivers. This can be compensated for by increasing the electrical power supplied for generating the ultrasonic transmission signal. To compensate for the temperature-dependent speed of sound, different carrier frequencies are used and, as a result, a constant wavelength is achieved. If the same electrical power is used in the case of a transfer function from electrical to mechanical power which is not constant, then directional characteristics are obtained for the different carrier frequencies, in which the angular dependence of the ultrasonic transmission signal is the same, since they have the same wavelength. However, the directional characteristics have different absolute values. As a result, a reflection by an object at the same position in the ultrasonic reception signal would be stronger or weaker as a function of the ambient temperature. In order to compensate for this, the electrical power for generating the ultrasonic transmission signal can be adjusted. For this purpose, for example, values as a function of the ambient temperature can be stored both for the carrier frequency and for the power in a look-up table, or formulae for calculating the carrier frequency and the power as a function of the temperature are stored in a processor with a memory.

When the ultrasonic reception signals are received, they essentially have the carrier frequency of the ultrasonic transmission signals. Since ultrasonic reception signals of different carrier frequency can be converted into electrical signals differently, ultrasonic reception signals of equal strength could be converted into electrical signals of different strength as a function of their carrier frequency, which was selected as a function of the ambient temperature. In order to compensate for this, the amplification of the electrical signal can be adjusted. For this purpose, for example, values as a function of the ambient temperature and/or the carrier frequency can be stored in a look-up table, or formulae for calculating the amplification as a function of the ambient temperature and/or the carrier frequency are stored in a processor with a memory.

According to one embodiment, a directional characteristic of the ultrasonic transceiver at a first ambient temperature and a correspondingly selected carrier frequency differs from the directional characteristic of the ultrasonic transceiver at a different second ambient temperature and a correspondingly selected carrier frequency in terms of propagation angle and/or signal strength less than the directional characteristic of the ultrasonic transceiver at the first ambient temperature differs from the directional characteristic of the ultrasonic transceiver at the second ambient temperature in each case when the same carrier frequency is used. Changes in the carrier frequency as a function of the temperature should result in a directional characteristic of the ultrasonic transceiver which is as independent of temperature as possible. For this purpose, the electrical power for the ultrasonic transmission signal can also be adjusted. A constant-temperature directional characteristic is sometimes not possible over the entire desirable temperature range from −40° C. to 60° C. or to 80° C. on account of the properties of the ultrasonic transceiver; however, even the directional characteristic that changes less significantly with temperature can improve the method for surveying the external environment of a vehicle.

According to one embodiment, the carrier frequency is selected as a function of air humidity, air pressure or composition of the air. The ambient temperature is usually the most important parameter for the wavelength associated with a carrier frequency; additional factors such as air humidity, air pressure or composition of the air can also influence the wavelength at a carrier frequency. If data are present, for example from a corresponding sensor, these influences can also be taken into account in the selection of the carrier frequency.

According to one embodiment, the electrical power supplied for generating the ultrasonic transmission signal is selected as a function of air humidity, air pressure or composition of the air. Additional influences such as air humidity, air pressure or composition of the air can also be taken into account in the power for generating the ultrasonic transmission signal in order to compensate for influences on the conversion of electrical power into mechanical power of the ultrasonic transmission signal.

According to one embodiment, the ambient temperature of the ultrasonic transceiver is determined using a temperature sensor of the vehicle and/or external data, for example from the Internet, and/or using a temperature sensor of the ultrasonic transceiver, in particular a temperature sensor of an ASIC of the ultrasonic transceiver. Temperature sensors which measure the outside temperature of the vehicle, for example for warnings of ice formation, are often present in vehicles. The data from such a temperature sensor can be used to determine the ambient temperature. ASICS, as are frequently present in the structural module comprising the ultrasonic transceiver, can likewise contain temperature sensors, and these data can also be used to determine the ambient temperature. Vehicles are often equipped with means for accessing the Internet via which information about the local temperature is retrieved and used to determine the ambient temperature. An ambient temperature suitable for carrying out the method is the temperature of the air directly at the ultrasonic transceiver.

According to one embodiment, the ambient temperature is determined from measurements of the ultrasonic transceiver, in particular from measurement of temperature-dependent changes in the piezo effect of the diaphragm of the ultrasonic transceiver or from propagation time measurements, in particular between two adjacent ultrasonic transceivers at a known distance. In the case of such a measurement between two adjacent ultrasonic transceivers, the received signal strength at the ultrasonic transceiver is often very low, but may nevertheless be sufficient for the specific task of propagation time measurement. Such measurements can enable direct access to the ambient temperature of the air or of the ultrasonic transceiver.

Various methods for temperature measurement and data and information about temperatures can also be combined to determine the ambient temperature.

According to one embodiment, the ultrasonic transceiver is arranged on a front apron, a rear apron, or a bumper. For applications in a vehicle such as, for example, parking aids or automated pulling in and out of parking spaces, ultrasonic transceivers are mounted at such suitable locations on the vehicle. This results in technical requirements, for example on the robustness of the ultrasonic transceiver, and esthetic requirements on the ultrasonic transceivers.

The ultrasonic transceivers used are intended, for example, to be suitable for being attached to the front side of the vehicle at vehicle speeds above 100 km/h and/or up to 250 km/h and for withstanding falling raindrops; the ultrasonic transceivers are intended, for example, to be suitable for drying and functioning again as quickly as possible after the vehicle has been traveling through rain or snow; the ultrasonic transceivers are intended, for example, to impair the aerodynamics of the vehicle as little as possible. Such requirements are poorly met, for example, by an ultrasonic horn, the opening and shape of which leads to turbulence and is associated with a deterioration in the aerodynamics and would introduce snowflakes, rain or spray into the horn.

According to one embodiment, the ultrasonic transceiver is embodied with a diaphragm that is flat toward the external environment of the vehicle. For example, a flat diaphragm is embodied without attachments or structures, such as horns, adaptation layers, e.g. λ/4 layers, and/or is arranged flat in the surface of a front apron, a rear apron or a bumper. A flat diaphragm adapts well to the aspect of a vehicle. Water droplets or thawing snow can easily drip off a flat diaphragm, which is mounted in particular perpendicular to the horizontal plane of the vehicle. A flat diaphragm interferes with the aerodynamics of the vehicle only a little and provides wind forces with little area to target.

According to one embodiment, the flat diaphragm of the ultrasonic transceiver is in direct contact with the air of the external environment of the vehicle and/or is lacquered. A diaphragm, for example a metal diaphragm, in particular a lacquered diaphragm, is resistant to falling raindrops and/or wind. Dispensing with adaptation layers, e.g. λ/4 layers, may reduce the efficiency when converting electrical to mechanical power, but can increase the robustness of the ultrasonic transceiver with respect to environmental influences.

The invention furthermore proposes a device for surveying an external environment of a vehicle, comprising: an ultrasonic transceiver configured to transmit ultrasonic transmission signals into the external environment of the vehicle and to receive ultrasonic reception signals from the external environment of the vehicle; a temperature determination unit for determining the ambient temperature of the ultrasonic transceiver; a selection unit for selecting a carrier frequency of the ultrasonic transmission signals of the ultrasonic transceiver as a function of the ambient temperature of the ultrasonic transceiver.

The units described in the present case, for example, the temperature determination unit or selection unit, can be implemented by hardware and/or software. For example, the units can be implemented on a microprocessor together with associated storage means. The microprocessor including storage means can be formed, for example, on a central controller of the motor vehicle or as an ASIC close to the ultrasonic transceiver. The microprocessor can receive external data, for example from the Internet, relating to the ambient temperature, for example via a data bus.

According to one embodiment, the ultrasonic transceiver is embodied with a diaphragm that is flat toward the external environment of the vehicle. In particular, in this case the flat diaphragm of the ultrasonic transceiver is in direct contact with the air of the external environment of the vehicle or is lacquered. A lacquered, flat diaphragm arranged flush with a vehicle part can easily integrate into the appearance of the vehicle, deterioration of the aerodynamics of the vehicle can be prevented, and/or rain and snow can be removed from the ultrasonic transceiver by the airflow.

According to one embodiment, a bumper, a front apron, a rear apron, a sill, a door, a tailgate, a roof or a motor vehicle comprises the device for surveying an external environment of a vehicle or it is attached to the underbody. The device for surveying an external environment of a vehicle can be integrated, for example, into a component which is then mounted in the bumper, in the front apron or in the rear apron. The device can also be distributed over multiple components of the motor vehicle, for example over a controller located, for example, in the engine compartment, and an ultrasonic transceiver which is arranged on the bumper, on the front apron or on the rear apron.

In addition, a computer program product is proposed comprising instructions which, when the program is executed by a computer, cause said computer to carry out the method described above.

A computer program product, for instance a computer program means, can be provided or supplied, for example, as a storage medium such as a memory card, a USB stick, a CD-ROM, a DVD, or also in the form of a downloadable file from a server in a network. This may take place, for example, in a wireless communication network by transmitting a corresponding file containing the computer program product or the computer program means.

The embodiments and features described for the proposed device apply to the proposed method and vice versa the embodiments and features described for the proposed method also apply accordingly for the proposed device.

Further possible implementations of the invention also comprise not explicitly mentioned combinations of features or embodiments described above or below with regard to the exemplary embodiments. A person skilled in the art will in this case also add individual aspects as improvements or additions to the respective basic form of the invention.

Further advantageous configurations and aspects of the invention form the subject matter of the dependent claims and of the exemplary embodiments of the invention that are described below. The invention is explained in more detail below on the basis of preferred embodiments with reference to the accompanying figures.

FIG. 1 shows a schematic top view of a motor vehicle having ultrasonic transceivers and an obstacle;

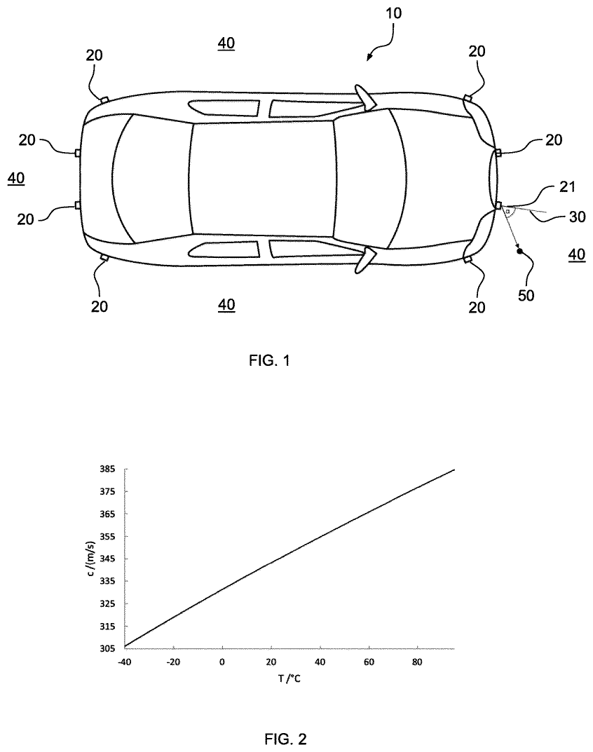

FIG. 2 shows a graph with an illustration of the dependence of a speed of sound c of an ultrasonic transmission signal in air on a temperature T;

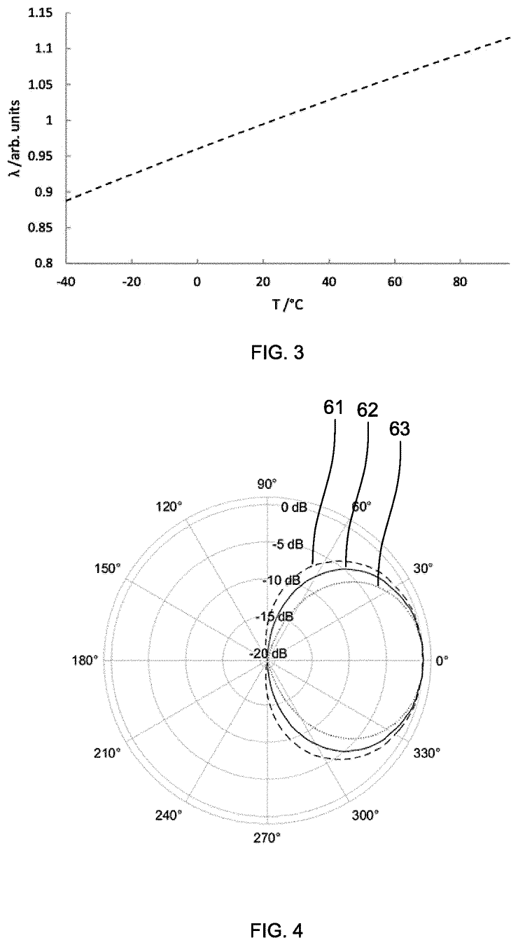

FIG. 3 shows a graph with an illustration of the dependence of a wavelength 2 of the ultrasonic transmission signal on the temperature T;

FIG. 4 shows a polar diagram with an illustration of the influence of the temperature T on a directional characteristic of an ultrasonic transceiver;

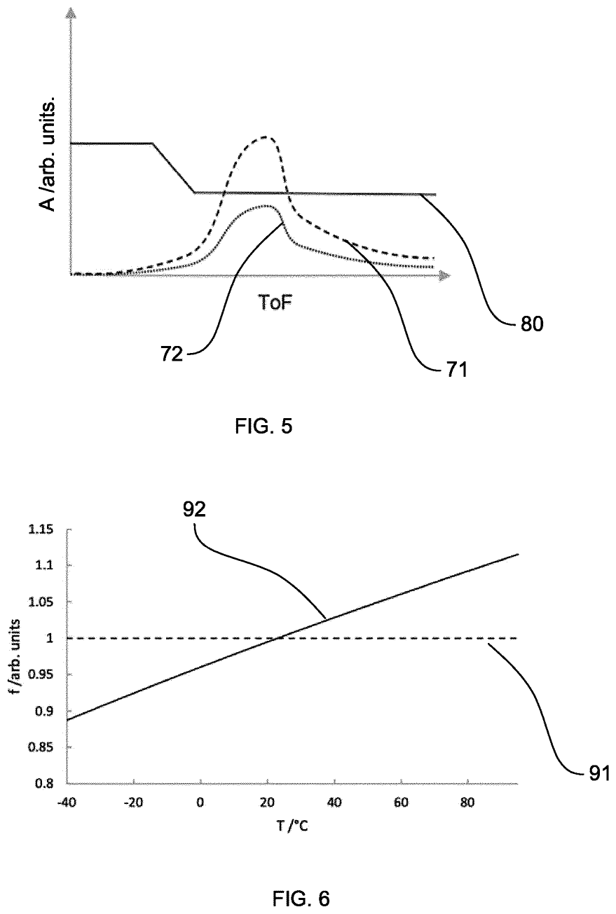

FIG. 5 shows a graph with an illustration of a reflection of the ultrasonic transmission signal of the ultrasonic transceiver by an obstacle outside the sensor axis at different temperatures;

FIG. 6 shows a graph with an illustration of an adaptation of a carrier frequency of the ultrasonic transmission signal as a function of the temperature T in order to compensate for the effect of the temperature on the wavelength λ;

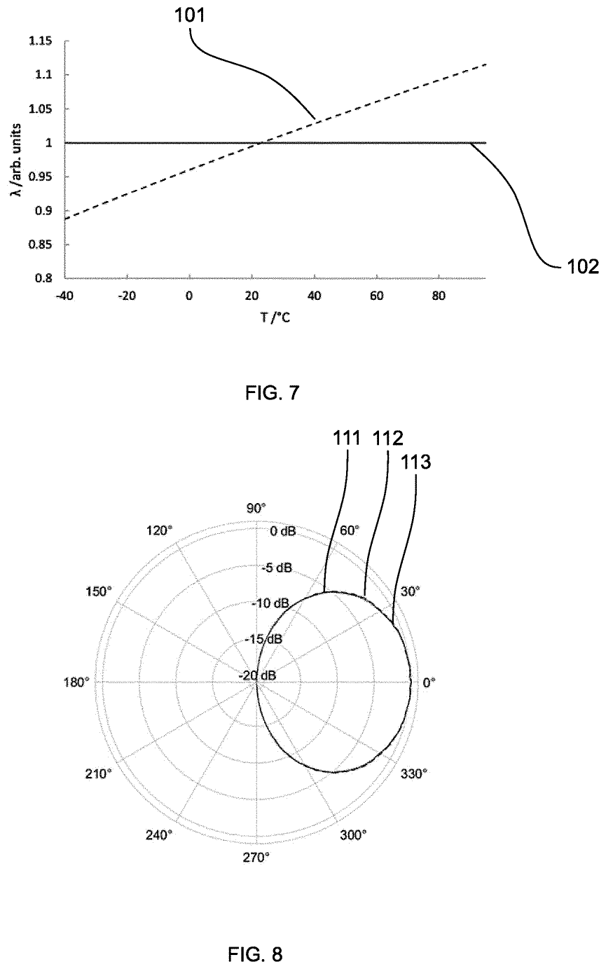

FIG. 7 shows a graph with an illustration of the compensation of the effect of the temperature T on the wavelength λ in the air by adapting the carrier frequency of the ultrasonic transmission signal;

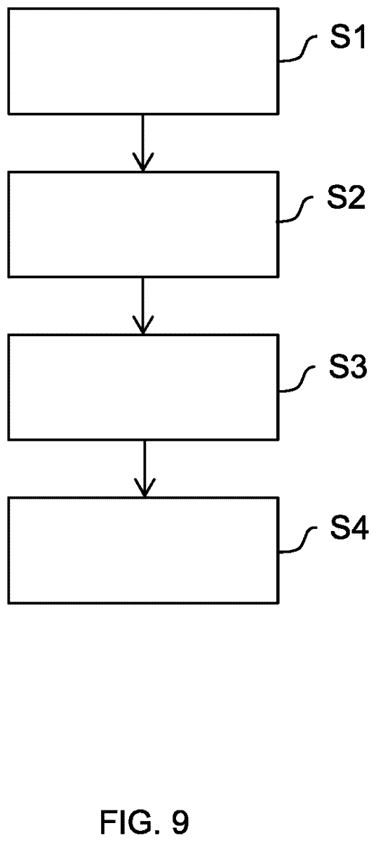

FIG. 8 shows a polar diagram with an illustration of a compensated influence of the temperature T on the directional characteristic of an ultrasonic transceiver;

FIG. 9 shows a flowchart for a method for surveying an external environment of a vehicle with an ambient-temperature-dependent carrier frequency of an ultrasonic transceiver; and

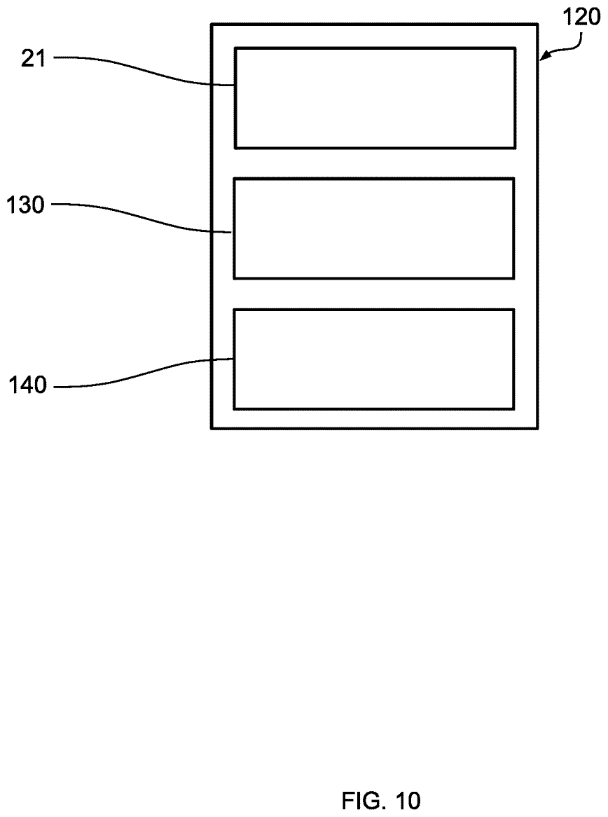

FIG. 10 schematically shows a device for surveying an external environment of a vehicle.

Identical or functionally identical elements are denoted by the same reference signs in the figures, unless stated otherwise.

FIG. 1 shows an exemplary vehicle, a motor vehicle 10 having multiple ultrasonic transceivers 20, 21. The multiple ultrasonic transceivers 20, 21 are arranged in a front apron and in a rear apron, both not visible in the top view, of the motor vehicle 10. In the schematic illustration, the ultrasonic transceivers 20, 21 are shown superimposed for better recognizability. In most motor vehicles 10, the ultrasonic transceivers 20, 21 are embodied as surface-flush, so that they do not protrude or only protrude minimally out of the front apron or rear apron.

The ultrasonic transceivers 20, 21 are often embodied with a pot-shaped diaphragm, the flat side of which is not lacquered in the color of the motor vehicle 10. The flat region of the diaphragm is fitted into the plane of the front apron or rear apron. A cylindrical region adjoins the flat region of the diaphragm. The cylindrical region may have a greater wall thickness than the flat region. The diaphragm can be connected by way of the cylindrical region to a housing of the ultrasonic transceiver 20, 21. The ultrasonic transceivers 20, 21 are often only recognizable by a silicone decoupling between the front apron or rear apron and the ultrasonic transceiver 20, 21, which is visible as a circle. The diaphragm of the ultrasonic transceivers 20, 21 is excited by a piezo element. In this case, the ultrasonic transceiver 20, 21 is an electroacoustic transducer which converts electrical signals into sound and vice versa.

A main emission direction 30 for an ultrasonic transmission signal is shown for the ultrasonic transceiver 21. The ultrasonic transceiver 21 emits the ultrasonic transmission signal into an external environment 40 of the motor vehicle 10. The ultrasonic transceiver 21 is an anisotropic emitter. The ultrasonic transceiver 21 emits its maximum power perpendicular to the flat side of the diaphragm. In the horizontal plane through the main beam direction 30, the ultrasonic transmission signal has a beam angle of approximately 150°. In the vertical plane through the main beam direction 30, the beam angle is approximately 90°.

An obstacle 50 is shown in the periphery of the propagation of the ultrasonic transmission signal. If the beam angle of the ultrasonic transmission signal in the horizontal plane now decreases, it may be that the obstacle 50 is no longer struck or no longer struck with sufficient signal strength of the ultrasonic transmission signal of the ultrasonic transceiver 21. If the obstacle 50 is also not struck by ultrasonic transmission signals from another ultrasonic transceiver 20, it can no longer be identified by the ultrasonic transceivers 20, 21. Such a change in the beam angle can be caused by a change in the ambient temperature of the ultrasonic transceivers 20, 21.

A directional characteristic of the ultrasonic transceiver 21 for the emission of ultrasonic transmission signals is substantially influenced by the ratio of the wavelength in the propagation medium air and the geometric dimensions of the diaphragm, in particular the flat side of the diaphragm, and/or the bending vibration. This applies in a similar manner to the directional characteristic when receiving ultrasonic reception signals, i.e. the angle-dependent sensitivity of the ultrasonic transceiver 21.

FIG. 2 shows a graph with an illustration of the dependence of a speed of sound c in m/s of an ultrasonic transmission signal in air on a temperature T of the air. In the range of the ambient temperature relevant for vehicles between approximately −40° C. and 80° C., the speed of sound varies between approximately 305 m/s and approximately 375 m/s, with temperatures up to approximately 60° C. usually being relevant. In the case of a constant carrier frequency of the ultrasonic transmission signal, the wavelength thus increases.

FIG. 3 shows a graph with an illustration of the dependence of a wavelength λ of the ultrasonic transmission signal in arbitrary units, arb. units, on the temperature T of the air. If a fixed carrier frequency is set for an ultrasonic transmission signal of the ultrasonic transceiver 21, the wavelength thus decreases by more than 10% in the case of cooling of the air in the environment 40 of the ultrasonic transceiver 21 from 20° C. to −40° C. and increases by more than 5% in the case of an increase from 20° C. to 60° C.

The relationships between the speed of sound c and various air conditions such as temperature, pressure, air humidity, CO2 concentration, are known; see, for example, Bohn, Dennis A. “Environmental Effects on the Speed of Sound”. Journal of The Audio Engineering Society 36(1988 ):223-231 or Cramer, Owen P. “The variation of the specific heat ratio and the speed of sound in air with temperature, pressure, humidity, and CO2 concentration.” Journal of the Acoustical Society of America 93(1993 ): 2510-2516. In addition to the temperature of the air, it is thus also possible to take into account additional factors and parameters which have an influence on the wavelength of the ultrasonic transmission signal.

FIG. 4 shows a polar diagram with an illustration of the influence of the temperature T on the field of sight or the directional characteristic 61, 62, 63 of an ultrasonic transceiver 21. The polar diagram shows a vertical section through the angle-dependent distribution of the strength of the emission of the ultrasonic transceiver 21. The ultrasonic transceiver 21 is aligned with its main beam direction in the direction 0° in the representation plane. If one now moves in the vertical plane on a circle around the ultrasonic transceiver 21, the radiation power received at a detector decreases as the angle increases, until, after the maximum beam angle is reached, there is no sound pressure, or only a very low sound pressure, toward one side. The angle range at which the sound pressure or level of the ultrasonic transmission signals decreases by 3 dB in both directions with respect to the main beam direction can be defined as the beam angle; this is the case at approximately 80° to 100° in FIG. 4. A horizontal section through the angle-dependent distribution of the intensity of the emission of the ultrasonic transceiver 21 would result in a beam angle of approximately 140° to 160° for the directional characteristic 61, 62, 63 of the ultrasonic transceiver 21.

The polar diagram now shows the directional characteristic 61 for 60° C., the directional characteristic 62 for 20° C. and the directional characteristic 63 for −40° C. The beam angle of the directional characteristics 61, 62, 63 increases as the temperature increases. The flat side of the diaphragm of the ultrasonic transceiver 21 is a diaphragm region with a diameter of approximately 15 mm, which emits ultrasonic transmission signals directly into the environment 40 of the motor vehicle 10. The directional characteristic 61, 62, 63 now changes, with the excitation frequency remaining the same, with the change in the wavelength λ as a result of the temperature-dependent speed of sound c.

FIG. 5 shows a graph with an illustration of a reflection 71, 72 of the ultrasonic transmission signal of the ultrasonic transceiver 21 by an obstacle 50 at different temperatures. In the graph, the profile of the ultrasonic reception signal, as amplitude A in arbitrary units, arb. units, is illustrated against the time after the transmission of the ultrasonic transmission signal, the time of flight—ToF. If an obstacle 50 is not situated in the main beam direction of the ultrasonic transceiver 21, but at the edge of the beam angle, it may be that the obstacle 50 is still hit by the ultrasonic transmission signal with such a signal strength at a temperature of 60° C. in that the reflection 71 of the ultrasonic transmission signal in the ultrasonic reception signal exceeds a threshold value 80 for identifying obstacles. However, at a temperature of −40° C., the obstacle 50 lies outside the beam angle or in the outer range of the beam angle, such that the reflection 72 of the ultrasonic transmission signal in the ultrasonic reception signal remains below the threshold value 80 for identifying obstacles. The obstacle 50 would then be identified at 60° C. but the obstacle would no longer be identified at −40° C. The threshold value 80 can be varied within a time interval after emission of the ultrasonic transmission signal; this can be seen as a reduction in the graph of FIG. 5.

Even if, for the sake of simplicity, the example is based on a simple peak detection, the determination as to whether a reflection in the ultrasonic reception signal is identifiable as an echo, peak heights are also relevant for the classification of objects such as the obstacle 50, for example the distinction as to whether a low or a high object is involved.

FIG. 6 shows a graph with an illustration of an adaptation of a carrier frequency of the ultrasonic transmission signal as a function of the temperature T in order to compensate for the effect of the temperature on the wavelength λ. The carrier frequency f of the ultrasonic transmission signal is illustrated in arbitrary units, arb. units, as a function of the temperature T in ° C. In order to avoid the effect, illustrated in FIG. 4 and FIG. 5, of the change in the directional characteristic and of the consequences on the identification of obstacles, a temperature-dependent carrier frequency f 92 can be selected instead of a fixed, non-temperature-dependent, non-corrected carrier frequency f 91, such that the wavelength λ remains constant, or changes at least less than at a fixed carrier frequency f 91.

FIG. 7 shows a graph with an illustration of the compensation of the effect of the temperature T on the wavelength λ in the air by adapting the temperature-dependent carrier frequency f 92 of the ultrasonic transmission signal. The wavelength λ in the air is illustrated in arbitrary units, arb. units, as a function of the temperature T in ° C. The graph shows the uncorrected curve of the wavelength λ known from FIG. 3 as a function of the temperature 101 at the fixed, non-temperature-dependent, uncorrected carrier frequency f 91. However, if the temperature-dependent carrier frequency f 92 is used, the corrected curve of the wavelength λ is obtained as a function of the temperature 102. A constant wavelength λ can be achieved by changing the carrier frequency f 92 as a function of the temperature.

FIG. 8 shows a polar diagram with an illustration of the compensated influence of the temperature T on the directional characteristic of the ultrasonic transceiver 21. The polar diagram of FIG. 8 corresponds to the polar diagram of FIG. 4, wherein the temperature-dependent carrier frequency f 92 from FIG. 6 was used instead of the constant carrier frequency in FIG. 4 with the resulting change in the wavelength λ as a result of the temperature-dependent speed of sound c. The temperature-dependent carrier frequency f 92 keeps the wavelength λ constant, as illustrated in the corrected curve of the wavelength λ as a function of the temperature in FIG. 7. As a result, the curves for the directional characteristic 111 for 60° C., the directional characteristic 112 for 20° C. and the directional characteristic 113 for −40° C. lie one above the other. The beam angles of the directional characteristics 111, 112 and 113 are the same and an effect as illustrated in FIG. 5 can be avoided.

In order that the directional characteristics 111, 112 and 113 are identical for the different ambient temperatures, the power for the ultrasonic transmission signals can also be adapted in addition to the carrier frequency if a transfer function for the conversion of electrical to mechanical power in the range of the carrier frequencies used is not constant.

The necessary values for the electrical power for generating the ultrasonic transmission signal can originate, for example, from a stored sensor model; are measured and stored on the production line in a sensor-specific manner; are ascertained on the motor vehicle by determining the transfer function from electrical to acoustic power, for example from the electrical or from acoustic data.

Values for the temperature-dependent carrier frequency f 92 and possibly also for the power of the ultrasonic transmission signal at the respective selected carrier frequency f 92 can be stored in a look-up table, such that temperatures or temperature ranges are respectively assigned to carrier frequencies and signal strengths, powers or powers of the ultrasonic transmission signal, so as to achieve as a result of the selection, a directional characteristic that does not change with the temperature; as an alternative or in combination, formulae for calculation can be stored in a microprocessor with a memory. Both a look-up table and a calculation can also be implemented in hardware, for example ASICs.

It is not always possible to achieve a completely temperature-independent directional characteristic over the desired temperature range. By way of example, the transfer function of electrical power into sound power of the ultrasonic transceiver 21 may result in the carrier frequency not being able to be changed to such an extent that the wavelength λ remains constant-temperature without the sound power being reduced. However, partial compensation of the temperature effects also represents an improvement. FIG. 7 shows how the constant wavelength λ 102 is achieved at a temperature-dependent carrier frequency f 92. A wavelength λ, which lies between the constant wavelength λ 102 and the uncorrected curve of the wavelength λ, also yields an improvement. When the temperature-dependent carrier frequency f 92 is selected, the directional characteristics of the ultrasonic transceiver 21 at two different temperatures differ less in terms of propagation angle and/or signal strength than the directional characteristics when the same carrier frequency is used at the two (different) temperatures.

As an alternative or in addition to the adaptation of the electrical power for generating the ultrasonic transmission signals, the amplification of an electrical signal, which arises as a result of a conversion of the ultrasonic reception signal into the electrical signal, can also be set in the reception path as a function of the ambient temperature or of the carrier frequency used. Alternatively or in combination, formulae for calculation can also be stored in a microprocessor with a memory for this purpose. Both a look-up table and a calculation can also be implemented in hardware, for example ASICs. The necessary values for the amplification can originate, for example, from a stored sensor model; are measured and stored on the production line in a sensor-specific manner; are ascertained on the motor vehicle by determining the transfer function from electrical to acoustic power, for example from the electrical or from acoustic data.

FIG. 9 shows a flowchart for a method for surveying an external environment of a vehicle with an ambient-temperature-dependent carrier frequency of an ultrasonic transceiver.

The ambient temperature of the ultrasonic transceiver 21 is determined in a step S1. The determination can be carried out by means of an external temperature sensor present in the motor vehicle 10. However, these sensors or their evaluation means are often slow. To determine the temperature, it is also possible to use an ASIC which is arranged on the ultrasonic transceiver 21 and has its own temperature sensor. It is also possible to use temperature data taken from the Internet and combinations of various methods to determine the ambient temperature. For the best possible implementation of the method, a temperature of the air directly at the diaphragm, in particular the flat side of the diaphragm, of the ultrasonic transceiver 21 is desirable.

The temperature can also be determined from measurements at and using the ultrasonic transceiver 21. The piezo effect of the piezo element with which the diaphragm is excited is dependent on temperature. As a result of this temperature dependence, the electrical characteristic of the electroacoustic transducer changes. The electrical characteristic can be measured using actuation electronics and the temperature can thus be ascertained.

The carrier frequency of the ultrasonic transmission signal of the ultrasonic transceiver 21 is selected as a function of the ambient temperature of the ultrasonic transceiver 21 in a step S2. The selection can be carried out by means of a look-up table. Alternatively, formulae or algorithms using which the carrier frequency is calculated from the ambient temperature can also be stored in a processor with a memory.

The ultrasonic transmission signal is transmitted using the ultrasonic transceiver 21 into the external environment of the vehicle in a step S3. The ultrasonic transmission signal is transmitted at the selected carrier frequency and can be encoded in a wide variety of forms, for example amplitude or frequency modulation, frequency or phase shift keying, or a multiplexing method such as time division multiplexing. As a rule, a multiplicity of ultrasonic pulses are emitted one after the other, between which there are pauses. The ultrasonic transceiver is sensitive to the ultrasonic reception signal shortly after the emission of an ultrasonic pulse in the pause between the pulses.

The ultrasonic reception signal is received by the ultrasonic transceiver 21 in a step S4. In the received ultrasonic reception signal, reflections of the ultrasonic transmission signal at objects, for example obstacle 50, can be sought and the distance between the objects and the ultrasonic transceiver 21 can be inferred from propagation time calculations.

FIG. 10 schematically shows a device 120 for surveying an external environment of a vehicle.

The ultrasonic transceiver 21 is configured to transmit ultrasonic transmission signals into the external environment 40 of the vehicle 10. The ultrasonic transceiver 21 is an electroacoustic transducer. An electrical signal at a carrier frequency excites a piezo element. The piezo element excites a diaphragm to oscillate, the oscillations being transmitted as ultrasound to the air. The diaphragm may be of pot-shaped design; a flat, round region with a diameter of approximately 15 mm adjoins a cylindrical region. In particular, the flat region generates ultrasonic transmission signals in the air as ultrasonic waves. Ultrasonic waves impinging on the diaphragm can excite the piezo element as ultrasonic reception signals and generate a piezo voltage which can be measured.

A temperature determination unit 130 is configured to determine the ambient temperature of the ultrasonic transceiver 21. The temperature determination unit 130 can comprise, for example, a thermocouple and the evaluation electronics thereof. The temperature determination unit can also comprise a data input and evaluation electronics. Vehicle-external data, for example from temperature data from the Internet, or vehicle-internal data, for example from a temperature sensor of the motor vehicle 10, can be received via the data input and evaluated in the temperature determination unit 130. The temperature determination unit 130 can be realized, for example, by means of a microprocessor having a memory, for example by means of an ASIC.

A selection unit 140 serves to select the carrier frequency of the ultrasonic transmission signals of the ultrasonic transceiver 21 as a function of the ambient temperature of the ultrasonic transceiver 21. The selection unit 140 can be realized, for example, by means of a microprocessor having a memory, for example by means of an ASIC. In particular, the selection unit 140 can also be realized using the same microprocessor as the temperature determination unit 130.

The ultrasonic transceiver 21, the temperature determination unit 130 and the selection unit 140 may be arranged in or on a housing.

Although the present invention has been described on the basis of exemplary embodiments, it is modifiable in a variety of ways.

### LIST OF REFERENCE SIGNS

10 Motor vehicle
20, 21 Ultrasonic transceiver
30 Main beam direction
40 External environment
50 Obstacle
61 Directional characteristic at 60° C.
62 Directional characteristic at 20° C.
63 Directional characteristic at −40° C.
71 Reflection in the ultrasonic reception signal at 60° C.
72 Reflection in the ultrasonic reception signal at −40° C.
80 Threshold value
91 Uncorrected carrier frequency f
92 Temperature-dependent carrier frequency f
101 Uncorrected curve of the wavelength λ as a function of temperature
102 Corrected curve of the wavelength λ as a function of temperature
111 Corrected directional characteristic at 60° C.
112 Corrected directional characteristic at 20° C.
113 Corrected directional characteristic at −40° C.
120 Device for surveying an external environment of a vehicle
130 Temperature determination unit
140 Selection unit for selecting a carrier frequency
S1 Determination of an ambient temperature of the ultrasonic transceiver
S2 Selection of the carrier frequency of the ultrasonic transmission signal of the ultrasonic transceiver
S3 Transmission of the ultrasonic transmission signal using the ultrasonic transceiver 21 into the external environment of the vehicle
S4 Reception of the ultrasonic reception signal using the ultrasonic transceiver 21

1. A method for surveying an external environment of a vehicle, comprising:
determination of an ambient temperature of an ultrasonic transceiver of the vehicle;
selection of a carrier frequency of an ultrasonic transmission signal of the ultrasonic transceiver as a function of the determined ambient temperature of the ultrasonic transceiver;
transmission of the ultrasonic transmission signal at the selected carrier frequency into the external environment of the vehicle by the ultrasonic transceiver and
reception of an ultrasonic reception signal by means of the ultrasonic transceiver.

2. The method as claimed in claim 1, wherein an electrical power supplied for generating the ultrasonic transmission signal and/or an amplification of an electrical signal into which the ultrasonic reception signal is converted is selected as a function of the selected carrier frequency of the ultrasonic transmission signal.

3. The method as claimed in claim 1, wherein a directional characteristic of the ultrasonic transceiver at a first ambient temperature and a correspondingly selected carrier frequency differs from the directional characteristic of the ultrasonic transceiver at a different second ambient temperature and a correspondingly selected carrier frequency in terms of propagation angle and/or signal strength less than the directional characteristic of the ultrasonic transceiver at the first ambient temperature differs from the directional characteristic of the ultrasonic transceiver at the second ambient temperature in each case when the same carrier frequency is used.

4. The method as claimed in claim 1, wherein the carrier frequency is selected as a function of air humidity, air pressure, or composition of the air.

5. The method as claimed in claim 2, wherein the electrical power supplied for generating the ultrasonic transmission signal is selected as a function of air humidity, air pressure, or composition of the air.

6. The method as claimed in claim 1, wherein the ambient temperature of the ultrasonic transceiver is determined using a temperature sensor of the vehicle and/or data provided externally of the vehicle.

7. The method as claimed in claim 1, wherein the ambient temperature is determined from measurement of temperature-dependent changes in a piezo effect of a diaphragm of the ultrasonic transceiver or from propagation time measurements.

8. The method as claimed in claim 1, wherein the ultrasonic transceiver is arranged on a front apron, a rear apron, a sill, a door, a tailgate, a roof, an underbody, or a bumper.

9. The method as claimed in claim 1, wherein the ultrasonic transceiver is embodied with a diaphragm that is flat toward the external environment of the vehicle.

10. The method as claimed in claim 9, wherein a flat region of the diaphragm of the ultrasonic transceiver is in direct contact with the air of the external environment of the vehicle and/or is lacquered.

11. A device for surveying an external environment of a vehicle for carrying out the method as claimed in claim 1, comprising:
an ultrasonic transceiver configured to transmit ultrasonic transmission signals into the external environment of the vehicle and to receive ultrasonic reception signals from the external environment of the vehicle;
a temperature determination unit for determining the ambient temperature of the ultrasonic transceiver; and
a selection unit for selecting a carrier frequency of the ultrasonic transmission signals of the ultrasonic transceiver as a function of the ambient temperature of the ultrasonic transceiver.

12. A bumper, front apron, rear apron, sill, door, tailgate, roof, underbody, or motor vehicle having a device as claimed in claim 11.

13. A computer program product, comprising commands which, upon the execution of the computer program product by a computer, prompt the computer to carry out the method as claimed in claim 1.
